(19) United States
(12) Patent Application Publication
(10) Pub. No.: US 2025/0095927 A1
(43) Pub. Date: Mar. 20, 2025

(54) SWITCHING DEVICE FOR CONDUCTING HIGH CONTINUOUS CURRENTS AND VERY HIGH SHORT-CIRCUIT CURRENTS

(71) Applicant: Schaltbau GmbH, Muenchen (DE)

(72) Inventor: Jens KNEBEL, Pfaffing (DE)

(73) Assignee: Schaltbau GmbH, Muenchen (DE)

(21) Appl. No.: 18/580,861

(22) PCT Filed: May 19, 2022
(86) PCT No.: PCT/EP2022/063575

§ 371 Date: Jan. 19, 2024

(30) Foreign Application Priority Data
Jul. 19, 2021 (DE) 10 2021 118 585.8

(51) Int. Cl. H01H 1/38

(52) U.S. Cl. CPC H01H 1/385

(57) ABSTRACT

Disclosed is a switching device having at least two contact locations wherein: each includes a movable contact and a fixed contact, one of the contacts being formed in a socket and the other contact being formed on a pin which can be received in the socket, and the movable contacts of both contact locations being in the form of a common component; one of the contacts at at least one of the contact locations has ribs, so that at the contact location a plurality of contact points is defined, the ribs being a separate component in the form of contact lamellae, and the contact lamellae being in the form of a high-current contact strip, which includes a resilient carrier strip having two boundary flanges and includes a plurality of contact webs, which run transversely to the boundary flanges and are connected to the boundary flanges.

The present invention relates to a switching device for conducting high continuous currents and very high short-circuit currents.

From DE 66 08 223 U, a contact arrangement for high continuous current loads with continuous currents of up to 2000 A and more is already known. The contact arrangement comprises a stationary contact piece and a cylindrical switching pin. The stationary contact piece is movably arranged on a contact housing and connected to an element that heats up and expands or contracts when current passes through the contact arrangement, and thereby either displaces, rotates or tilts the stationary contact piece from its rest position. During this movement of the stationary contact piece, sliding occurs between the contact surfaces that are in contact, which destroys an oxide skin that hinders the transition of current and reduces the contact resistance.

U.S. Pat. No. 4,039,786 shows an ultra-fast operating switch with a pin or bar-shaped movable contact arm. The contact arm is movably guided in a tubular guide. The contact arm can be moved by means of a drive rod connected to a relay and can be brought into engagement with a fixed contact. The fixed contact is sleeve-shaped and has a plurality of parallel flexible fingers at its end facing the contact arm, in which a rounded end of the contact arm can be accommodated. The tubular guide is connected to an external connecting cable by means of a metal plate, the fixed contact is connected to an external clamp.

DE 718 554 A discloses a gas-insulated switchgear or an electrical switch with arc extinguishing by a flowing pressurized medium. The switch comprises a movable contact configured as a pin, which can be brought into engagement with a fixed contact. In addition, the movable contact is guided in an intermediate contact and connected to a collective contact. In the closed position of the switch, the movable contact extends through the intermediate contact and is accommodated in the fixed contact. When the switch is open, the movable contact is retracted and only guided in the collective contact.

EP 2 525 455 A1 describes a gas-insulated switchgear with a bus-integrated disconnector. The bus-integrated disconnector comprises a pin-shaped movable contact which is guided in a movable lateral contact section. The movable contact can be moved via a lever element and brought into engagement with a fixed lateral contact section. This represents an electrically connected or closed state. The movable contact can be pulled out of the fixed lateral contact section again so that the disconnector is in an electrically disconnected state.

US 2016/0035501 A1 also discloses a gas-insulated power switching device comprising a fixed electrode and a movable electrode arranged opposite each other in a container filled with insulating gas; and a bar-shaped movable conductor electrically connecting the fixed electrode and the movable electrode. The fixed electrode and the movable electrode have a contactor through which current flows to the movable conductor. The fixed electrode and the movable electrode have ring-shaped sliding elements, wherein the ring-shaped sliding elements are arranged on both sides of the contactor.

It is known that switching devices can have a lack of short-circuit strength. After a short-circuit event, such devices are often destroyed and therefore unusable and must be replaced.

It is therefore the object of the present invention to provide a switching device which avoids the problems known from the prior art and which, in particular in the unseparated state, i.e. in the contacted state, can conduct high continuous currents and even higher short-time currents without welding.

The problem is solved by the features of independent claim 1, according to which a switching device for conducting high continuous currents and very high short-circuit currents has a solution to the problem in accordance with the invention if the switching device comprises at least two contact locations, wherein each contact location comprises a movable contact and a fixed contact, one of the contacts of each contact location being formed in a socket and the other contact of each contact location being formed on a pin which can be received in the socket, and the movable contacts of both contact locations being in the form of a common component, wherein one of both contacts at at least one of the contact locations has ribs, so that at the contact location, a plurality of contact points is defined, the ribs are configured as a separate component in the form of contact lamellae, which is arranged on the corresponding contact of each contact location and the contact lamellae are in the form of a high-current contact strip, which comprises a resilient carrier strip having two boundary flanges and a plurality of contact webs extending transversely to the boundary flanges and connected to the boundary flanges, wherein contact pieces are riveted onto the contact webs.

This solution according to the invention allows the switching device to conduct high continuous currents and even higher short-time currents in the contacted state without welding of the contacts at the contact locations. At the same time, only low actuating forces are required.

In the present case, high continuous currents are understood to mean operating currents of up to 1000 A. High or even higher short-time currents are in a range of up to 30 kA. Due to the fact that the contact locations are configured as plug-in contacts, wherein each contact location comprises a socket and a pin that can be received in the socket, and thus a contact is provided over the entire circumference of the pin and the socket receiving the pin, it can be ensured that the electromagnetic repulsive forces occurring at high currents, for example at short-circuit currents, do not lead to an opening of the contacts. Flutter effects, which can lead to welding of the contacts, are also avoided. The short-circuit strength of the switching device is increased and the conduction of high continuous currents is ensured. Due to the fact that one of the two contacts on at least one of the contact locations has ribs, the transition resistance is reduced and welding of the contact locations is avoided and safe conduction of high continuous currents of up to 1000 A and short-circuit currents of up to 30 kA is made possible. In a simple configuration, this can be achieved by configuring the ribs as a separate component in the form of contact lamellae, which is arranged at the corresponding contact of each contact location. The contact lamellae are preferably configured as a ring-shaped strip or sleeve, i.e. as a high-current contact strip, which can either be simply plugged onto the pin or inserted into the socket. This therefore enables a simple structure, the spring force is geometrically located in the ring-shaped arranged contact lamellae.

Preferably, the sockets and the at least one pin are aligned coaxially to one another. In a simple configuration, the sockets and the at least one pin are cylindrically shaped. This allows the contacts to be simply plugged into each other. However, other cross-sectional shapes of socket and pin are of course possible, as long as the contact locations can be simply plugged into one another and pulled apart, thus closed and opened.

Preferred embodiments of the present invention are the subject matter of the sub-claims.

In a preferred embodiment of the present invention, it may be provided that the fixed contact of each of the at least two contact locations is formed in one socket each and the movable contacts of the at least two contact locations are formed on a common pin. When switching, the common pin is thus moved into or out of the sockets. This enables a simple and stable configuration.

In particular, it is then also possible that at least one third contact location is provided, which comprises a fixed contact configured as a socket and a movable contact, wherein the movable contact of the third contact location is also formed on the common pin. This enables simple interconnection of at least three circuits.

According to a further particularly preferred embodiment of the present invention, it may be provided that the pin is received in at least one of the sockets in each switching position. In the open position, the pin is then received in at least one socket, in a closed position in at least two sockets. In this way, increased stability is achieved.

According to a further particularly preferred embodiment of the present invention, it may be provided that the carrier strip is made of spring steel and the contact pieces are made of copper. The carrier strip made of spring steel, preferably stainless spring steel, has high mechanical strength and excellent relaxation resistance and thus generates the mechanical strength and the contact force. The contact pieces made of highly conductive copper ensure a high current-carrying capacity.

According to yet another embodiment, it may be provided that one of the two contacts comprises two sets of ribs arranged next to each other at at least one of the contact locations in the longitudinal direction of the sockets and the pin. This parallel connection, thus the arrangement of several ribbed areas next to each other, can further increase the current-carrying capacity of the switching device.

In order to increase the stability of the switching device, it may be provided that the pin has a central bore running in the longitudinal direction of the pin, which is in engagement with a centering bolt.

A further increase in the stability of the switching device can be achieved by the fact that each of the sockets is received in a solid block.

According to yet another embodiment, it can be provided that each of the solid blocks is electrically conductively connected to a connecting terminal. In this way, a simple connection is possible.

In order to enable safe and stable guidance of the at least one movable pin, it can be provided that the pin is movable by means of at least one cylinder, preferably by means of two cylinders.

In order to enable a wide range of applications, it can be provided that the switching device is configured as a normally open contact or as a normally closed contact or as a changeover contact. This is made possible by different versions of the switching axis.

According to a further particularly preferred embodiment of the present invention, it is provided that the switching device is configured as a manual disconnector. Preferably, the switching device is configured as a manual disconnector for safe, galvanic separation of the battery/voltage source and load in the event of maintenance on battery-operated trains. In the operating state, thus in the closed state, the manual disconnector can carry all occurring currents, thus operating currents up to 1000 A and short-time currents of 30 kA.

An embodiment of the present invention is explained in more detail below with reference to drawings. Therein:

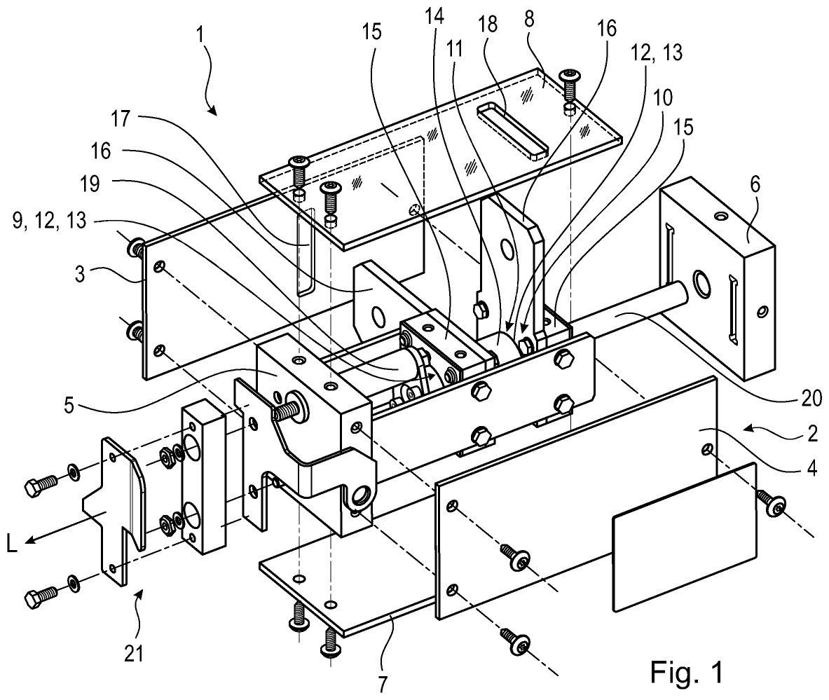

FIG. 1 shows a switching device according to the invention in an exploded view;

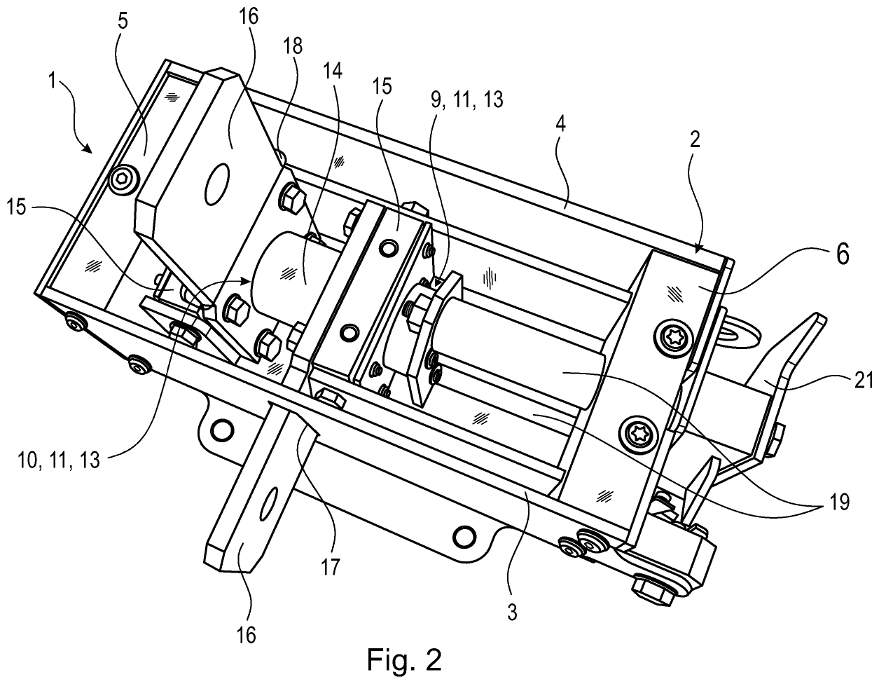

FIG. 2 shows the switching device according to the invention from FIG. 1 in the contacted state in a perspective view;

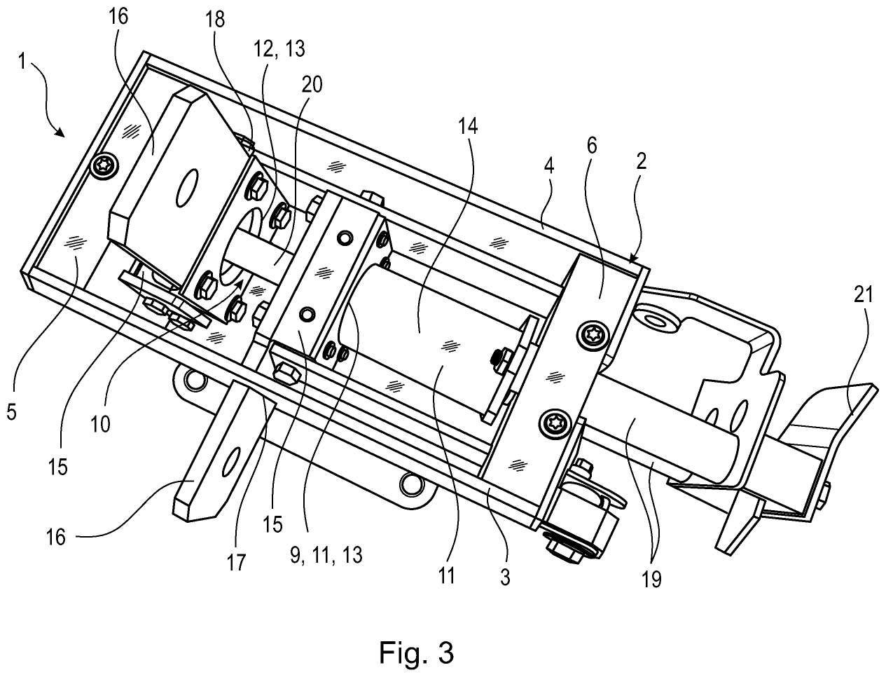

FIG. 3 shows the switching device according to the invention from FIG. 1 in the disconnected state in a perspective view;

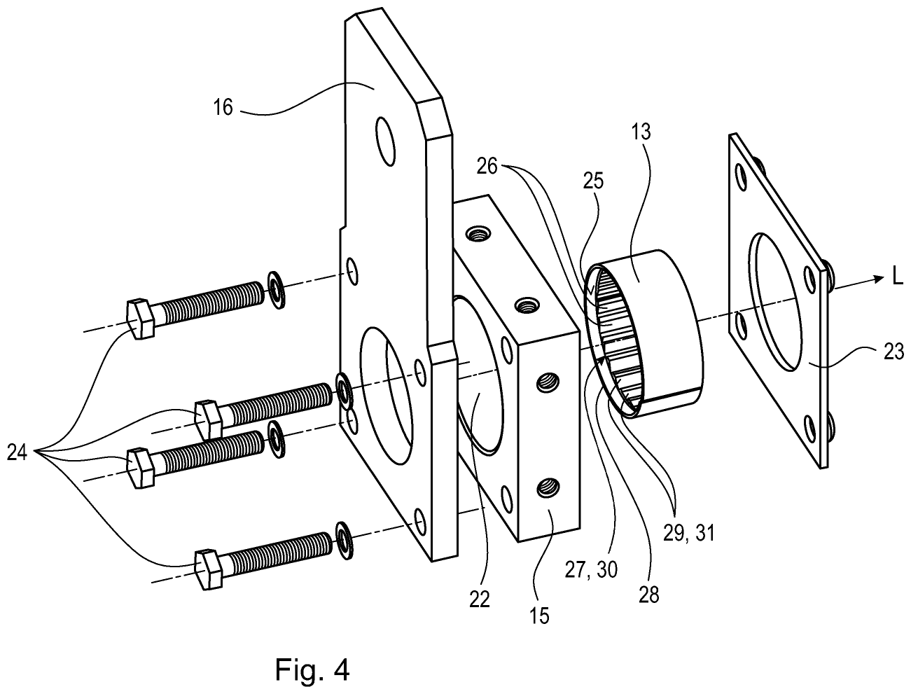

FIG. 4 shows a fixed contact of the switching device according to the invention from FIG. 1 in an exploded view; and

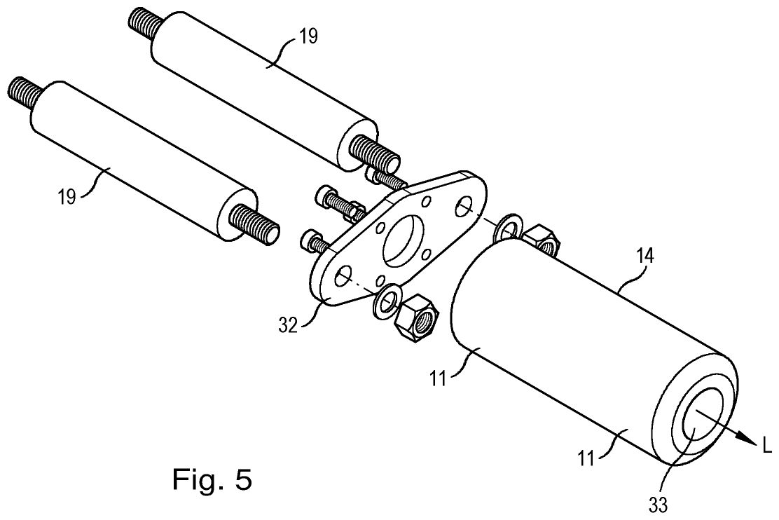

FIG. 5 shows a movable contact of the switching device according to the invention from FIG. 1 in an exploded view.

In the following explanations, identical parts are designated by identical reference signs. If a figure contains reference signs that are not described in more detail in the associated description of the figure, reference is made to preceding or subsequent descriptions of the figures.

FIG. 1 shows a switching device 1 according to the invention in an exploded view. The switching device 1 comprises a housing 2 with two side walls 3, 4, two end walls 5, 6, a base plate 7 and a cover 8. Two contact locations 9, 10 are formed in the housing 2. Each of the two contact locations 9, 10 comprises a movable contact 11 and a fixed contact 12. In the embodiment shown in FIG. 1, the two fixed contacts 12 are each formed as or in a socket 13. The sockets 13 are cylindrical. Each of the sockets 13 is received in a solid block 15. The blocks 15 are each electrically conductively connected to a connecting terminal 16. In the rear side wall 3 in FIG. 1, a slot 17 is formed through which one of the connecting terminals 16 is guided to the outside. Similarly, a further slot 18 is formed in the cover 8, through which the second of the connecting terminals 16 is guided to the outside.

The movable contacts 12 are formed on a pin 14 which can be received in the sockets 13. The pin 14 is also cylindrical and is configured such that it can be inserted into and withdrawn from the sockets 13. The sockets 13 and the pin 14 are thus arranged coaxially to one another. In order to be able to move the pin 14 relative to the sockets 13—and thus to open and close the contact locations 9, 10—the pin 14 is movably guided by two cylinders 19, which are slidingly mounted on one of the end walls 5 of the switching device 1. The two cylinders 19 are connected to a switching mechanism 21. The cylinders 19 are moved via this switching mechanism 21 and transmit the switching movement to the movable pin 14 with the movable contacts 11 formed on it.

On the other end face 6 of the switching device 1, a centering bolt 20 is attached. The centering bolt 20 is also coaxial to the sockets 13 and the pin 14. The pin 14 has a central longitudinal bore in which the centering bolt 20 is received and thus contributes to secure guidance of the pin 14.

FIG. 2 shows a top view of the switching device 1 in the contacted state in a perspective view. The switching mechanism 21 is in the retracted position. This means that the cylinders 19 are retracted to the maximum into the housing 2 of the switching device 1 and have brought the movable pin 14, or the two movable contacts 11 formed thereon, into engagement with both sockets 13, which form fixed contacts 12. The movable pin 14 is thus in engagement with both sockets 13, both contact locations 9, 10 are closed and the switching device 1 is in the operating state. Due to the configuration of the contact locations 9, 10, which is further described below, all currents that occur, i.e. operating currents of up to 1000 A and short-time currents of up to 30 kA, can be conducted.

FIG. 3 shows a top view of the switching device 1 in the disconnected state in a perspective view. In the disconnected state, the switching mechanism 21 is in the maximum extended position. This means that the cylinders 19 are maximally extended out of the housing 2 of the switching device 1. The movable pin 14 is thus pulled out of one of the sockets 13, shown on the left in FIG. 3. Thus, the contact location 10 is open. At the other contact location 9, the movable pin 14 is still in engagement with the socket 13. FIG. 3 now also shows the centering pin 20 on which the movable pin 14 is guided.

FIG. 4 shows an exploded view of a detail of the switching device 1 of FIG. 1, namely the configuration or arrangement of the fixed contacts 12 in the switching device 1. The arrangement of the fixed contacts 12 at both contact locations 9, 10 is identically configured, but rotated by 90° relative to each other in the switching device 1. The fastening of each of the fixed contacts 12 comprises a solid block 15, in which a central bore 22 is formed. In the central bore 22, one of the sockets 13 is received in each case. The sockets 13 are held captively in the solid blocks 15 via the connecting terminals 16 and a retaining plate 23. A connection between the solid block 15, the retaining plate 23 and the connecting terminals 16 is preferably made by fastening means such as the screws 24 shown in FIG. 4.

Each of the sockets 13 has ribs 26 on its inner side 25, thus the side that comes into contact with the movable pin 14 and on which the respective fixed contact 12 is formed. Due to the ribs, a plurality of defined contact points are formed at each of the contact locations 9, 10. The current to be transmitted is therefore distributed over a plurality of contact points, so that only a portion of the total current has to be transmitted to the mating contact at each contact point. In this way, the contact resistance is reduced.

In the case shown in FIG. 4, a sleeve-shaped high-current contact strip 27 is arranged in the socket 13, which forms the ribs 26. The high-current contact strip 27 comprises a resilient carrier strip 30 with two boundary flanges 28 and a plurality of contact webs 29 running perpendicular to the boundary flanges 28. A contact piece 31 is riveted onto each of the contact webs 29. The carrier strip 30 is preferably made of spring steel, in particular stainless spring steel, the contact pieces 31 are made of copper. The contact pieces 31 made of copper have a high heat absorption capacity, allowing a very high short-circuit current carrying capacity to be achieved. The spring force required at the contact locations is geometrically contained in the ring-shaped high-current contact strip, thus arranged with an even radial distribution.

It is also possible to configure the ribs as contact lamellae. Furthermore, it would also be conceivable to form the ribs on the movable contacts, thus on the movable pin. In this case, sleeves made of a high-current contact strip could be applied to the pin as described above, in which the contact webs and thus also the contact pieces are formed on the outside of the sleeve. Furthermore, it is also conceivable to form two or more sets of ribs arranged parallel to each other in the direction of the longitudinal axis of the pin or sockets at each contact location. This can be done by arranging two or more of the sleeve-shaped high-current contact strips next to each other in parallel in the direction of the longitudinal axis L of the pin or sockets.

FIG. 5 shows an exploded view of a further detail of the switching device 1 from FIG. 1, namely the movable pin 14 with the cylinders 19 connected to it. The cylinders 19 are connected to the movable pin 14 via a retaining plate 32. The connection between the cylinders 19, the retaining plate 32 and the movable pin 14 is preferably also made via screw connections. The movable pin 14 has a central bore 33, which extends in the longitudinal direction L of the pin 14 and thus also in the longitudinal direction L of the sockets 13. The centering pin 20 (see FIG. 3) can be received in the central bore 33. The movable contacts 11 are formed on the pin 14.

Preferably, the switching device 1 is configured as a manual disconnector for safe galvanic separation of the battery/voltage source and load in the event of maintenance on battery-operated trains, which can conduct all occurring currents, i.e. operating currents of up to 1000 A and short-time currents of 30 kA, in the operating state when the disconnector is closed.

Depending on the configuration of the switching axis, the switching device can also be configured as a normally open contact or a changeover contact. It is therefore also possible for the switching device to comprise three or more contact locations. In this case, it is possible to connect several switching circuits. Several sockets are then preferably arranged one behind the other in the housing of the switching device. The sockets are aligned coaxially to each other and form the fixed contacts. The movable contacts are all formed on a common movable pin. The movable pin is also aligned coaxially with the sockets and can interconnect several or all sockets.

Preferably, the switching device does not require any switching capacity and is used for load-free switching.

### LIST OF REFERENCE SIGNS

1 switching device
2 housing
3 side wall
4 side wall
5 end wall
6 end wall
7 base plate
8 cover
9 contact location
10 contact location
11 movable contact
12 fixed contact
13 socket
14 pin
15 solid block
16 connecting terminal
17 slot
18 slot
19 cylinder
20 centering bolt
21 switching mechanism
22 central bore
23 retaining plate
24 screw
25 inner side of the socket
26 ribs
27 high-current contact strip
28 boundary flanges
29 contact webs
30 carrier strip
31 contact pieces
32 retaining plate
33 bore
L longitudinal direction

1. A switching device (1) for conducting high continuous currents and very high short-circuit currents having at least two contact locations (9, 10), wherein each contact location comprises a movable contact (11) and a fixed contact (12), one of the contacts (12) of each contact location (9, 10) being formed in a socket (13) and the other contact (11) of each contact location (9, 10) being formed on a pin (14) which can be received in the socket (13), and the movable contacts (11) of both contact locations (9, 10) being in the form of a common component; wherein one of the contacts (12) at at least one of the contact locations (9, 10) has ribs (26), so that at the contact location (9, 10) a plurality of contact points is defined, the ribs being a separate component in the form of contact lamellae, said component being arranged on the corresponding contact of each contact location, and the contact lamellae being in the form of a high-current contact strip (27), which comprises a resilient carrier strip (30) having two boundary flanges (28) and comprises a plurality of contact webs (29), which run transversely to the boundary flanges (28) and are connected to the boundary flanges (28), wherein contact pieces (31) are riveted onto the contact webs (29).

2. The switching device (1) according to claim 1, characterized in that the fixed contact (12) of each of the at least two contact locations (9, 10) is formed in a respective socket (13) and the movable contacts (11) of the at least two contact locations (9, 10) are formed on a common pin (14).

3. The switching device according to claim 2, characterized in that at least one third contact location is provided, which comprises a fixed contact configured as a socket and a movable contact, wherein the movable contact of the third contact location is also formed on the common pin.

4. The switching device (1) according to claim 1, characterized in that the pin (14) is received in at least one of the sockets (13) in each switching position.

5. The switching device (1) according to claim 1, characterized in that the carrier strip (30) is made of spring steel and the contact pieces (31) are made of copper.

6. The switching device according to claim 1, characterized in that one of the two contacts has two ribs arranged next to each other at at least one of the contact locations in the longitudinal direction of the sockets and the pin.

7. The switching device (1) according to claim 1, characterized in that the pin (14) has a central bore (33) which runs in the longitudinal direction of the pin (14) and is in engagement with a centering bolt (20).

8. The switching device (1) according to claim 2, characterized in that each of the sockets (13) is received in a solid block (15).

9. The switching device (1) according to claim 8, characterized in that each of the solid blocks (15) is electrically conductively connected to a connecting terminal (16).

10. The switching device (1) according to claim 2, characterized in that the pin (14) is movable by means of at least one, preferably two cylinders (19).

11. The switching device (1) according to claim 1, wherein the switching device is configured as a normally open contact or as a normally closed contact or as a changeover contact.

12. The switching device (1) according to claim 1, wherein the switching device is configured as a manual disconnector.
